(19) United States
(12) Patent Application Publication
(10) Pub. No.: US 2008/0169169 A1
(43) Pub. Date: Jul. 17, 2008

(54) ASSEMBLY LINE FOR FLEXIBLE PROCESSING OF WORKPIECES

(75) Inventor: Torsten Huebner, Solingen (DE)

Correspondence Address: BRINKS HOFER GILSON & LIONE, P.O. BOX 10395, CHICAGO, IL, 60610, US

(73) Assignee: Supfina Grieshaber GmbH & Co. KG, Wolfach (DE)

(21) Appl. No.: 12/019,851

(22) Filed: Jan. 25, 2008

Related U.S. Application Data
(63) Continuation of application No. PCT/EP2006/009327, filed on Sep. 26, 2006.

(30) Foreign Application Priority Data
Jan. 10, 2005 (DE) 10 2005 047 250.8

(51) Int. Cl. B65G 47/22

(52) U.S. Cl. 198/345.3

(57) ABSTRACT

The inventive production line for producing workpieces includes several processing cells (21) which are positioned in row side by side and a transport device (31) for transporting the workpiece(s) to be processing to the processing cells (21) or for removing them therefrom, wherein the machining cells (21) of the production line are arranged on a base module (13), the transport means (31) comprises a guide rail (33) extending along at least the entire length of the base module (13) and at least one transport slide (35) is placed on the guide rail (33).

### CROSS-REFERENCE TO RELATED APPLICATIONS

This application is a continuation of International Application No. PCT/EP2006/009327 filed on Sep. 26, 2006, which claims the benefit of DE 10 2005 047 250.8, filed Oct. 1, 2005. The disclosures of the above applications are incorporated herein by reference.

### FIELD

The invention concerns an assembly line in which workpieces can be processed in various processing steps.

### BACKGROUND

The statements in this section merely provide background information related to the present disclosure and may not constitute prior art.

If a large number of processing steps must be carried out on a workpiece, it can thereby occur, that the workpiece successively runs through different processing machines and each of the processing machines undertakes one or more processing steps. The disadvantages with this concept are the great requirement for space on this assembly line, which consists of different machines, and its low flexibility with respect to a conversion to another workpiece.

Another concept which has already proven itself in practice involves processing centers which have a rotary table with several workpiece carriers about which various processing stations are arranged. By rotating the rotary table, the workpiece holders are moved from one processing station and along with it the workpieces situated in the workpiece carriers.

Processing cells into which different process modules can be installed as needed are known from DE 103 13 792 A1, DE 102 29 341 A1, DE 100 12 579 and DE 197 41 671 A1. Moreover, several of these autonomous processing modules can be arranged in a row. The disadvantage with this design is that, in connection with the processing cells, the workpieces are successively transported through the various processing cells and processed there. Due to this rigid processing sequence, the cycle time of the overall processing cell is determined by the cycle time of the processing module with the longest cycle time.

### SUMMARY

The invention is based upon the objective of increasing the performance of conventional assembly lines and processing modules and at the same time of improving their flexibility.

The present disclosure provides an assembly line for manufacturing workpieces with several processing cells arranged alongside one another in a row and with a transport apparatus for transporting the workpiece(s) into the processing cells and out of the processing cells, whereby all processing cells of an assembly line are arranged on a base module, whereby the transport apparatus includes a guide rail, whereby the transport rail extends over at least the entire length of the base module, and whereby at least one transport carriage is arranged on the guide rail.

By the arrangement of the processing cells in a row, the harmonizing of the cycle times of the various processing cells present in processing centers with rotary tables is eliminated, so that each of the processing cells can be loaded with workpieces corresponding to its performance. In this way, an optimal capacity utilization of each individual processing cell is attained.

In conjunction with the assembly line of the invention, the transport system of the invention, which includes a transport rail and at least one transport carriage, has the advantage that the workpieces need not be transported with the aid of the transport carriage(s) to the next processing cell, but rather the direct transport of one workpiece from one processing cell to the next but also to one even further removed processing cell is also possible.

If, for example, one processing step has a significantly greater cycle time than the other processing steps, two processing cells can be provided in the line concept of the invention which perform parallel to one another on different workpieces the processing step(s) with the greatest cycle time. By means of the parallel processing of two workpieces on two processing stations which conduct the same processing step, the output rate of the entire assembly line can be doubled in the ideal case by interposition of a further processing cell. In this way, considerable economic advantages can be realized.

For example, when a finish processing has a cycle time of 10 seconds and a previously stored or subsequent polishing process has a cycle time of 30 seconds, the cycle time of the entire line can be reduced to 15 seconds or even to 10 seconds through the parallel use of 2 or 3 polishing modules.

Furthermore, the modular concept of the assembly line of the invention also offers considerable advantages in connection with clamping workpieces. For example, when a first plane surface is to be processed at an angle to the long axis of the workpiece, the workpiece is clamped in a chuck with long clamping jaws. If now the opposite plane surface is to be polished parallel to the first plane surface, it is advantageous, if the workpiece is briefly clamped for this second plane finish processing process, so that the workpiece is aligned on its first plane surface. These different workpiece clamping tasks can mostly not be integrated into one chucking apparatus. This is possible without further ado using two different finishing cells of which one processes the first plane surface and the second processes the second plane surface, so that an improved product quality results.

It is moreover possible with the line concept of the invention to exchange processing stations arranged alongside each other in a row, if necessary, so that during conversion of the assembly line for the processing of another workpiece, an assembly line with optimal performance can be produced with little expense.

For the manufacturer of the assembly line of the invention there results the advantage, that it can offer a large number of the most varied assembly lines which consist of a number of standardized, easily observable processing and can be configured according to the wishes of the customer. In this way, considerable advantages result for the manufacturer of the assembly line of the invention with respect to delivery time and storage maintenance costs.

The modularity nonetheless also has considerable advantages for the user. If, namely, an assembly line is no longer needed because the product manufactured on it is no longer required, the processing stations, the base module and the transport system can be reused, among other things, for the construction of a new assembly line. In this way, investment costs are saved and the investment security for the buyer is dramatically increased. These advantages are against the background of constantly sinking product life cycles and the advance of new production techniques. The assembly line of the invention can be converted or supplemented with low assembly, time and cost expenditures within the framework of product and/or technology conversions.

The interchangeability and standardization of processing cells is further promoted, in that the processing cells are arranged on a base module.

Advantageously the base module has a grid and the breadth of the processing cells corresponds to the scale of the grid or a whole number multiple of the grid scale. In this way, the interchangeability of the module within an assembly line or the configuring of an assembly line is further simplified and facilitated in harmony with the demands of the customer.

The processing cells can execute cutting as well as non-cutting processing methods. With workpieces which must be manufactured with high precision, one or more processing cells can include a measuring apparatus so that their measured values are entered into the control unit of the subsequent processing cells. In this way, the precision of the workpieces manufactures is optimized and the rejection rate can go down toward zero.

After finishing the workpieces, the adherence to all relevant scales, surface geometry or surface roughness can be verified in a further processing cell, so that at the end of the assembly line, a one hundred percent quality control can occur fully automatically. Even the measured values of this verification statement can be entered into the control unit of the assembly line of the invention, so that the deviation of the actual values of the subsequent workpieces from the target values is further diminished.

It has proven advantageous in connection with the assembly line of the invention, if one or more workpiece spindles are provided which serve to accept and drive a workpiece.

It has furthermore proven advantageous, if the processing cells also have a rotary table with several workpiece carriers with whose the aid the workpieces can be fed one after the other to the processing spindle(s). Processing steps can be combined in a processing cell which are similar with respect to their cycle time and technological standards, so that the full capacity of all tool spindles of a processing cell are approximately equal.

Since due to the conditions of manufacture, the workpiece carriers of a rotary table have minor errors with regard to their alignment and/or their longitudinal axes do not run wholly parallel to the axis of rotation of the rotary table, it is provided in a further development of the invention, that the workpiece spindles can be pivoted about the X axis and/or about the Y axis manually or using a motor. In this way, it is guaranteed, that the axis of rotation of the workpiece spindles and the long axis of the workpiece carriers are aligned toward one another in such manner as the processing of the workpiece requires, despite any possibly existing manufacturing inaccuracies.

In processing steps, for example, if a cross polishing is desired or a sealing surface is to be executed slightly convex, it can be necessary, that the long axis of the tool spindles and the long axis of the workpiece carrier deviate from one another by an exactly defined amount. Even in this case, the desired grinding finish or the desired convexity can be set by means of the separate, motorized movement of the tool spindles around the X axis and/or about the Y axis.

Moreover the manufacturing inaccuracies in the manufacture of the rotary table or the directional deviations of the long axis of the workpiece carrier are automatically compensated for, so that the result of processing is independent of the inaccuracies of the rotary table mentioned.

In order to enable the transport of the workpieces into the assembly line of the invention and out of the assembly line of the invention on the one hand, and on the other to make possible a transport of the workpieces from one processing cell to another processing cell, a transport apparatus is provided which includes a guide rail. At least one transport carriage is arranged on the guide rail which has one or more workpiece grippers and/or workpiece turning units.

Preferably a transport carriage is provided between two processing cells which removes the workpiece(s) from one processing cell and feeds them to an adjacent processing cell. If two processing cells execute the same processing step parallel to each other, for example because the cycle time of this processing step is significantly greater than that of the remaining processing steps which are executed on the assembly line of the disclosure, then it is also possible that the workpieces are not transported from one processing cell to a directly adjacent processing cell with the aid of the transport apparatus, but are rather transported to a further removed processing cell.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

In order that the invention may be well understood, there will now be described an embodiment thereof, given by way of example, reference being made to the accompanying drawing, in which:

FIG. 1 is an isometric representation of an assembly line of the invention;

FIG. 2 is a side view of the assembly line of the invention;

FIG. 3 is an enlarged cut out from FIG. 1;

FIG. 4 is a view from above on the assembly line of the invention in a first position; and

FIG. 5 is a view from above on the assembly line of the invention in a second location.

### DETAILED DESCRIPTION

The following description is merely exemplary in nature and is not intended to limit the present disclosure, application, or uses.

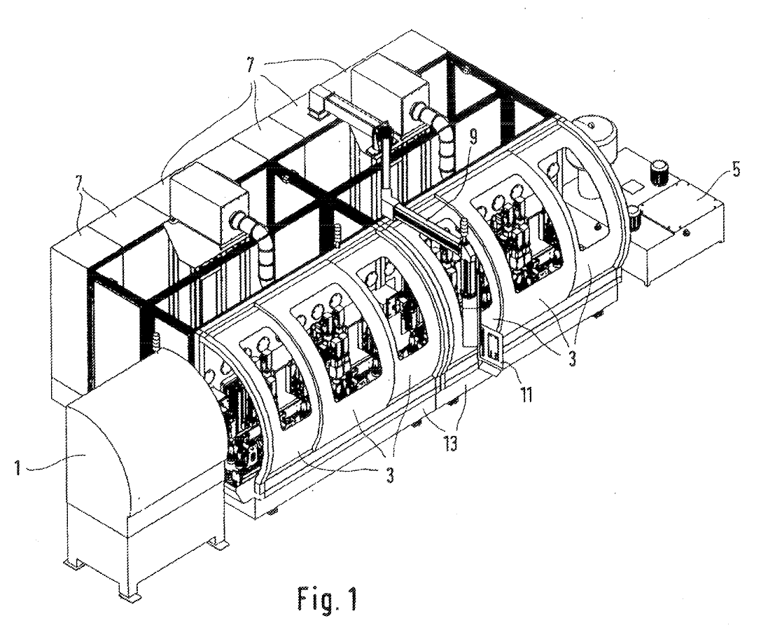

FIG. 1 shows an embodiment of an assembly line of the present disclosure. An automatic charging machine 1 is provided on the left side of the assembly line of the invention with the aid of which the assembly line of the invention is loaded with workpieces. A rinsing agent unit 5 is provided at the right end of the assembly line in FIG. 1. In the front part of the assembly line in FIG. 1, several processing cells (without reference numbers) which are arranged behind a spray arrester 3 are arranged in a row one alongside the other. At the back end of the assembly line in FIG. 1, various control cabinets 7 are arranged one beside the other. Here each control cabinet serves to actuate the processing cells lying before it. Naturally a higher level control unit which networks, coordinates and controls the various processing cells of the assembly line of the invention is necessary.

A control desk 11 above a bracket 9 is connected with the control cabinets 7. The processing cells and the control cabinets 7 are arranged on a base module 13. If the assembly line includes a large number of processing cells, two base modules 13 can also be arranged side by side. The length of the assembly line is not restricted to two base modules, but as many base modules and processing cells as needed can be arranged side by side in a row as required for the processing of the workpiece.

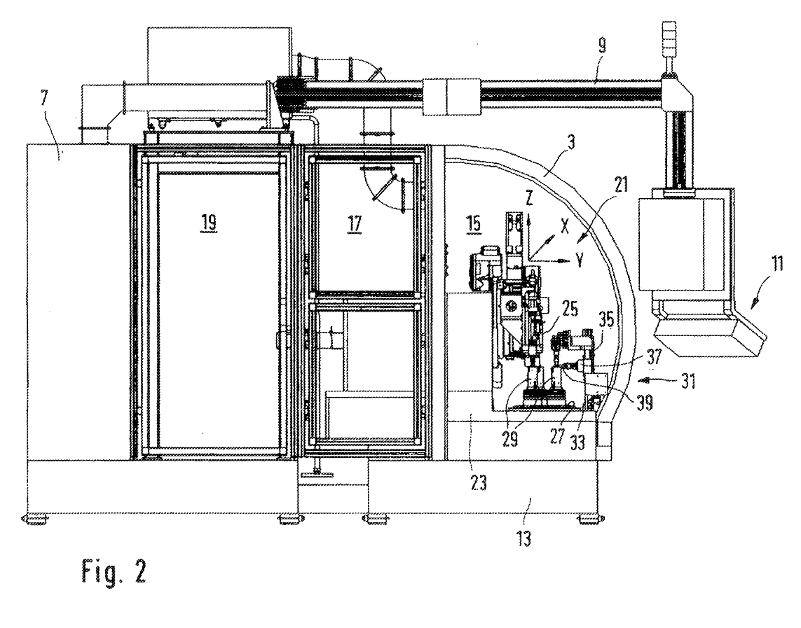

A side view of the assembly line of the invention is depicted in FIG. 2. Identical components are provided with identical reference numbers and what was said with regard to FIG. 1 correspondingly applies. It becomes clear in the side view, that the assembly line can be subdivided from front to back into four different regions. The front-most region is the so-called sanitary chamber 15 inside which the real processing of the workpiece takes place. The spray arrester 3 serves to separate the sanitary chamber 15 from its surroundings, so that coolants and lubricants which are used in processing the workpiece do not get into the environment. A so-called drying chamber 17 is provided behind the sanitary chamber 15.

A maintenance passage 19 is provided between the circuit and control cabinets 7 which improves accessibility to the control cabinets and also to the processing cells or the processing module.

A processing cell is depicted in the sanitary chamber 15 which is provided with the reference number 21 in its entirety. An assembly line of the invention consists of several processing stations 21 which in general have different functions.

The processing cell 21 visible in FIG. 2 has a rack 23 which is connected with the base module 13. One or more tool spindles 25 is fastened movable back and forth through carriages and guides (without reference numbers). Moreover several numerically controlled processing axes can be provided in various spatial directions or for conducting rotary motions. The long axis of the tool spindles 25 runs in the direction of the Z axis. It is possible, that the processing station 21 has not only 3 NC-controlled axes in the direction of the three spatial directions. Other NC axes are also possible in addition.

A rotary table 27 is fastened so as to rotate and latch beneath the tool spindle 25. One or more workpiece carriers 29 can be arranged on the rotary table 27. The workpiece carriers 29 serve, as the name already indicates, to carry and bring a workpiece (not represented) into the work area of the tool spindle 25. The rotary table 27 is latched in this position and the processing can be performed.

It is envisioned with the processing cell 21 of the invention, that the tool spindle 25 can be swiveled or tipped around the X axis and around the Y axis, so that the directions of the long axis of the tool spindle and the long axis of the workpiece carrier 29 have a defined angle in relation to each other.

As a rule, one will actuate the tool spindle 25 such that it runs parallel to the workpiece carrier. In the event of special requirements regarding the workpiece, it can nonetheless also be advantageous, if the two axes or directions enclose an angle in relation to each other. In this way it is, in particular, also possible to gauge the alignment errors of the workpiece carrier 29 following completion of the rotary table 27 and of the tool carriers 29 and to make these finishing inaccuracies available to the machine control unit as a correction value. In this way, a corresponding correction of the direction of the long axis of the tool spindle 25 can be undertaken for each tool carrier which is situated precisely in the work region of the tool spindle 25, so that in the end, the finishing inaccuracies of the workpiece carrier 29 and the rotary table 27 can be compensated for.

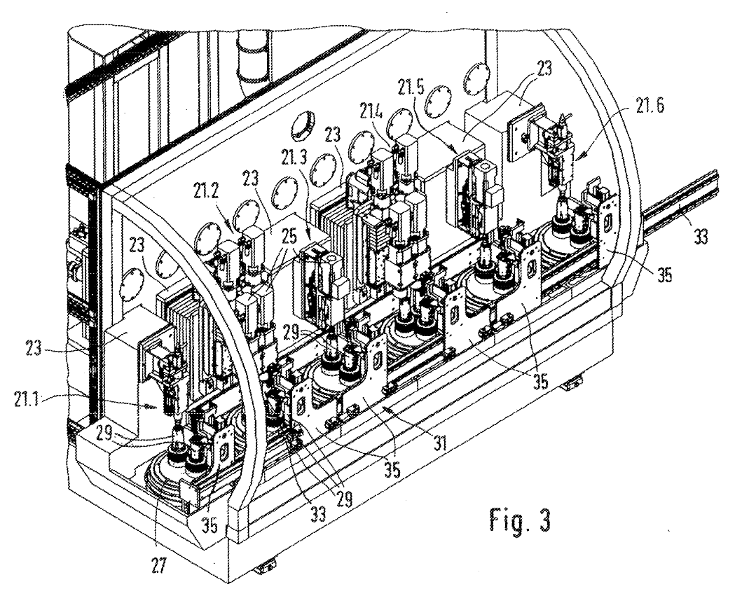

There is a transport apparatus 31 in front of the processing cell 21 which includes a guide rail 33 and a transport carriage 35 with a turning unit and a workpiece gripper 39. A cut-out from an assembly line of the invention consisting of six work stations is represented in FIG. 3 somewhat enlarged and without spray arrester 3.

The workpieces (not shown) pass through the assembly line from left to right. The first processing cell is a pre-measuring station 41 in which the workpieces are measured prior to processing. The results of the pre-measuring station 41 are forwarded to the internal machine control unit and processed, so that the desired end masses are attained in processing the workpieces in the subsequent processing cells in the shortest time. Defective workpieces can moreover be recognized by the pre-measuring station 41, so that they can be sorted out.

The rotary table 27 of the pre-measuring station 41 has two workpiece carriers 29. In this way, it is possible, that a workpiece is measured while at the same time the already measured workpiece is removed from the other workpiece carrier and a new workpiece is inserted. The loading and unloading of the rotary table 27 of the pre-measuring table 41 takes place just like the loading and unloading of the other processing cells 2-21.6 with the aid of the transport apparatus 31 which includes a guide rail 33 as well as several transport carriages 35. The transport carriages 35 are provided with a linear drive, so that they can remove a workpiece out of a processing cell and transport it to the neighboring processing cell and there insert it into the associated workpiece carrier 29 of the rotary table 27.

It is also possible to not transfer a workpiece into the directly adjacent processing cell, but rather, for example, to a further removed processing cell. This can be appropriate and sensible, if two processing cells execute the same processing steps parallel to each other on different workpieces because the cycle time of this processing step is significantly greater than that of the other processing steps in the other processing cells. In this way, it is possible to double the throughput through the assembly line in the ideal case, although only one additional processing cell is needed.

The processing cell 21.2 positioned to the right alongside the pre-measuring station 21.1 has two tool spindles 25 and a rotary table 27 with a total of three workpiece carriers 29, so that in an clamping of the workpiece (not represented), two processing steps can be performed one after another in the processing cell 21.2.

While the workpieces are being processed, the third workpiece carrier 29 is situated in the work region of the transport carriage or in a turning unit 27 arranged upon it or in a workpiece gripper (without reference number) arranged thereon and can either be rotated or turned or a new workpiece can be inserted and a ready processed workpiece can be removed and transported further to the neighboring processing cell 21.3. The processing cell 21.3 arranged to the right alongside the processing cell 21.2 has only one tool spindle 29 and one rotary table (without reference number) with two workpiece carriers 29.

A brush deburring is being undertaken in processing cell 21.3. The processing cells 21.4 and 21.5 correspond in their construction to the work stations 21.2 and 21.3. A verification station 21.6 is provided at the end of the segment of the assembly line represented in FIG. 3 in which the processed workpieces are measured. Possible deviations of the measured actual values from the target values are transmitted to the machine control unit and can thus be converted into corresponding correction magnitudes in connection with the processing of the subsequent workpieces, so that the manufacturing quality of the workpieces manufactured on the assembly line of the invention is constantly very high and deviate from one another only within very small limits.

The assembly line of the invention is not restricted to six processing cells in the configuration represented in FIG. 3, but rather that a basic feature of the assembly line of the invention consists of modular processing cells which each by itself has particular properties, and can implement one or several processing steps, being arranged in a row and being configured for processing of a workpiece with very high precision in a large number of items.

If the manufacture of a workpiece can be suspended and another workpiece is to be processed, the assembly line can be disassembled and the existing processing cells can be used to construct another assembly line which serves to manufacture another workpiece. It is also possible to exchange individual processing cells from the assembly line and replace them with others. In this way, the performance of the entire assembly line can be increased if, for example, the processing cell with the greatest cycle time is replaced by a new processing cell with a shorter cycle time.

In addition, considerable advantages result for the manufacturer of the assembly line of the invention with respect to manufacturing costs, since not every processing center is an individual manufacture which must be tailored individually to the wishes of the customer, but instead the manufacturer can combine the best suited stations into an assembly line from existing types of processing cells. As a rule one will merely manufacture the workpiece carriers 29 as special manufacture for the workpiece which is to be produced.

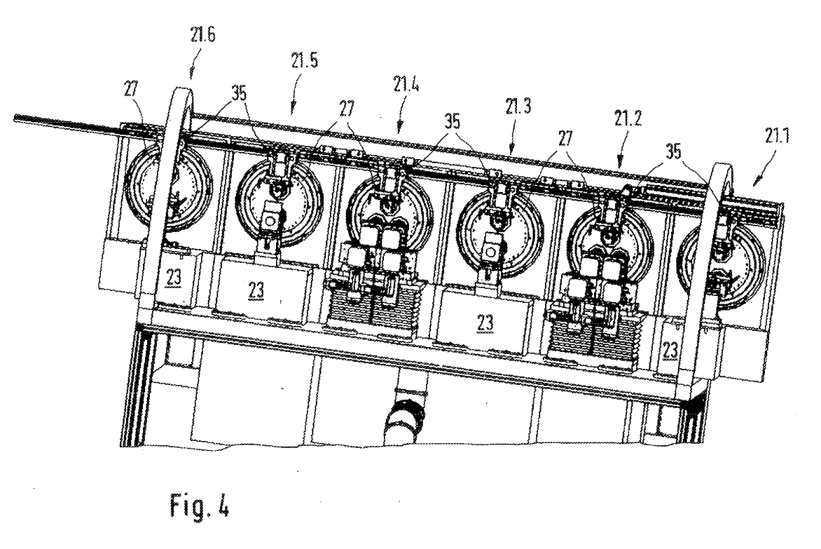

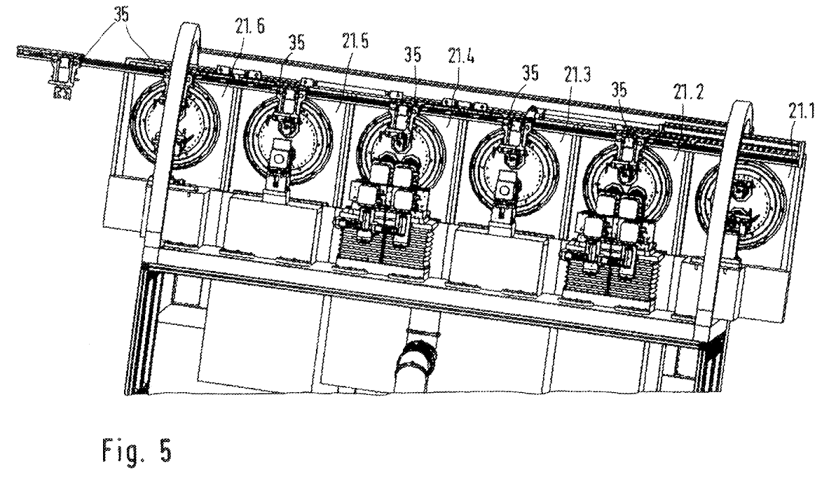

A view from above onto the assembly line in accordance with FIG. 3 is shown in FIG. 3. Moreover, the transport carriages 35 are so arranged, that the rotary tables 27 or the workpiece carrier 29 arranged on it (not visible in FIG. 4) are being loaded with a workpiece. In FIG. 5, the same assembly line is depicted, whereby the transport carriages 35 are shown in the position in which the workpieces are unloaded. This means in contrast to the depiction of FIG. 4, that the transport carriage 35 has moved a cell further in the processing direction.

It should be noted that the disclosure is not limited to the embodiment described and illustrated as examples. A large variety of modifications have been described and more are part of the knowledge of the person skilled in the art. These and further modifications as well as any replacement by technical equivalents may be added to the description and figures, without leaving the scope of the protection of the disclosure and of the present patent.

What is claimed is:

1. An assembly line for the manufacture of workpieces comprising a plurality of processing cells (21) arranged in a row alongside one another and with a transport apparatus (31) for transport of the workpieces in and out of the processing cells (21), whereby the processing cells (21) of an assembly line are arranged on a base module (13), whereby the transport apparatus (31) includes a guide rail (33), whereby the guide rail (33) extends over at least the entire length of the base module (13), and whereby at least one transport carriage (35) is arranged on the guide rail (33).

2. The assembly line according to claim 1, whereby the base module (13) has a grid, and whereby a width of the processing cells (21) corresponds to at least one of a grid scale or a whole number multiple of the grid scale of the base module (13).

3. The assembly line according to claim 2, whereby the grid scale of the base module (13) is approximately 600 mm.

4. The assembly line according to claim 1, whereby in at least one processing cell (21) the processing of the workpiece takes place by means of cutting processing methods.

5. The assembly line according to claim 1, whereby in at least one processing cell (21) the processing of the workpiece takes place by means of non-cutting processing methods.

6. The assembly line according to claim 1, whereby at least one processing cell has one or more tool spindles (25), and that the tool spindles (25) serve to accept and drive a tool.

7. The assembly line according to claim 1, whereby at least one processing cell (21) has a rotary table (27) with several workpiece carriers (29).

8. The assembly line according to claim 6, whereby the tool spindles (25) can be pivoted around at least one of an X axis and a Y axis.

9. The assembly line according to claim 8, whereby a swinging motion of the tool spindles (25) about the X axis and/or about the Y axis is conducted by a machine control unit by an actuation of one or more actuators.

10. The assembly line according to claim 1, whereby the workpiece is measured in at least one processing cell (21).

11. The assembly line according to claim 1, whereby at least one transport carriage (35) has at least one of a plurality of workpiece grippers (39) and workpiece turning units (37).

12. The assembly line according to claim 1, whereby at least one transport carriage (35) can introduce one or more workpieces into a workpiece carrier (29) of a processing cell (21), and whereby at least one transport carriage (35) can remove one or more workpieces from a workpiece carrier.

13. The assembly line according to claim 1, whereby at least one transport carriage (35) can remove one or more workpieces from a workpiece gripper (39) and/or a workpiece turning unit (37) and/or introduce one or more workpieces into the workpiece gripper (39) and/or into the workpiece turning unit (37) of another transport carriage (35).

14. The assembly line according to claim 1, whereby on one end of the assembly line a loading automat (1) is provided for loading the transport apparatus (31).
